(19) United States
(12) Patent Application Publication
(10) Pub. No.: US 2007/0113495 A1
(43) Pub. Date: May 24, 2007

(54) Modular assembly system

(76) Inventors: John F. Roberts, Charlotte, NC (US); Jean T. McGregor, Waxhaw, NC (US)

Correspondence Address: Giaccherini, Post Office Box 1146, Carmel Valley, CA, 92924, US

(21) Appl. No.: 11/370,499

(22) Filed: Mar. 2, 2006

Related U.S. Application Data
(63) Continuation-in-part of application No. 11/286,142, filed on Nov. 23, 2005.

(51) Int. Cl. E06B 3/26

(52) U.S. Cl. 52/202

(57) ABSTRACT

Methods and apparatus for modular combinations of structural elements (22) and connectors (30) that are sold as a set of unassembled or partially assembled parts (14), and are then transported and assembled by a consumer (10) having ordinary skill without special tools or expertise.

### CROSS-REFERENCE TO A RELATED PATENT APPLICATION & CLAIM FOR PRIORITY

The Present Patent Application is a Continuation-in-Part Patent Application, and is related to Pending Patent Application U.S. Ser. No. 11/286,142 filed on 23 Nov. 2005. The Applicants hereby claim the benefit of priority in accordance with “Sections 119 and 120 of Title 35 of the United States Code of Laws for any subject matter that is commonly disclosed in the Present and Parent Applications.

### FIELD OF THE INVENTION

The present invention pertains to methods and apparatus for manufacturing, marketing, retailing and assembling modular combinations of structural elements to furnish doors, panels, partitions, walls, enclosures or other constructions. More particularly, one preferred embodiment of the invention utilizes a number of generally planar elements that are assembled by an ordinary-skilled consumer. The invention may be embodied as a door, panel, partition or some other vertically-disposed structure for the home or office. A consumer purchases a relatively small package which contains a stack of the modular elements, transports the package to their home or office in the trunk, back seat or storage compartment of a conventional car or truck, and then assembles the modular elements without using special tools or hiring a contractor.

### BACKGROUND OF THE INVENTION

Every year, Americans purchase millions of doors for homes, offices and places of business. A vast majority of these doors are sold as completed and finished products. Many of these doors are delivered and installed by contractors. Conventional, pre-finished doors that are available at retail outlets like The Home Depot®, Lowe's® or Sears ® are generally too large to transport safely in the family car. These conventional doors may also be rather heavy, and are difficult to move and to carry through small areas. Many of these doors require the expertise of a contractor, and can not be put in place without special tools.

No currently available conventional door can be purchased in a package that is easy to carry and transport, and then can be assembled by the consumer without special tools or expertise. The development of such a product would satisfy long felt needs in the home and office furnishings business, and would constitute an advance in the hardware and construction industries.

### SUMMARY OF THE INVENTION

The present invention comprises methods and apparatus for providing structural elements which may be purchased in a kit that is contained in a small portable package. The consumer may purchase this product in a retail store, bring it home in a typical family car, and then assemble and install the product without special tools or expertise.

An appreciation of the other aims and objectives of the present invention, and a more complete and comprehensive understanding of this invention, may be obtained by studying the following description of preferred and alternative embodiments, and by referring to the accompanying drawings.

### A BRIEF DESCRIPTION OF THE DRAWINGS

FIG. 1 shows a family arriving at their local retailer.

FIG. 2 shows the family purchasing an EasyDoor™ Modular Assembly.

FIG. 3 illustrates the ease of transporting the EasyDoor™. After carrying the portable package out to the parking lot, the EasyDoor™ can be stowed in the trunk or in the back seat of a typical family car.

FIGS. 4 and 5 portray the quick and easy installation of the EasyDoor™ by an ordinarily-skilled consumer without special tools or expertise.

FIG. 6 exhibits the installation of alternative embodiments of the invention, which may include customized panels having different interchangeable colors, materials, prints, scenery or popular characters from books, cartoons or movies.

FIGS. 7 and 8 depict the assembly of one basic embodiment of the invention.

FIG. 9 furnishes a view of a connector that may be employed to assembly one of the embodiments of the invention.

FIGS. 10 and 11 depict the assembly of another embodiment of the invention.

FIG. 12 provides a detailed view of the assembly of one embodiment of the invention.

FIG. 13 offers a view of a snap-together door.

FIG. 14 shows the assembly of a snap-together door.

FIG. 15 portrays a pre-hung boxable door.

FIG. 16 exhibits a telescoping door.

FIG. 17 illustrates a folding door.

### A DETAILED DESCRIPTION OF PREFERRED & ALTERNATIVE EMBODIMENTS

I. A First Set of Preferred & Alternative Embodiments of the Invention.

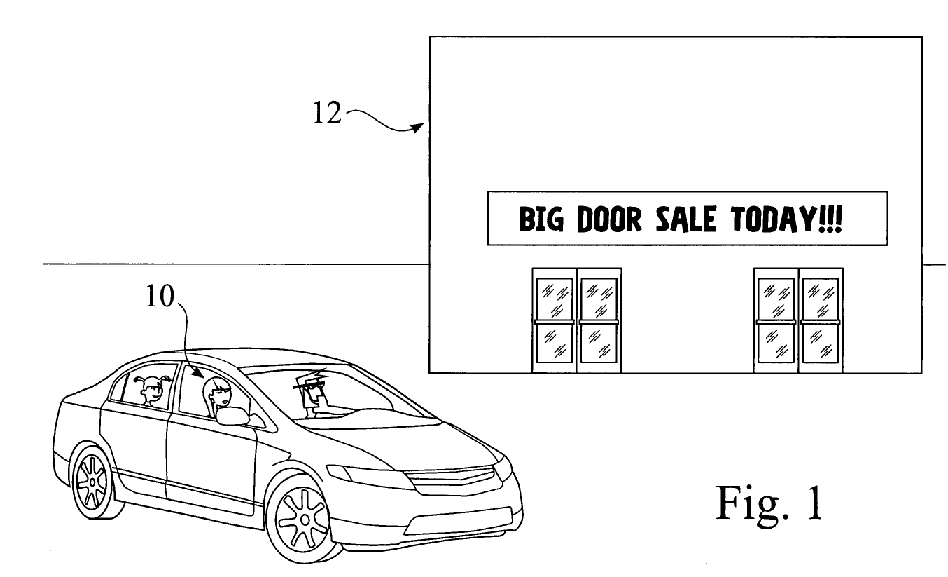

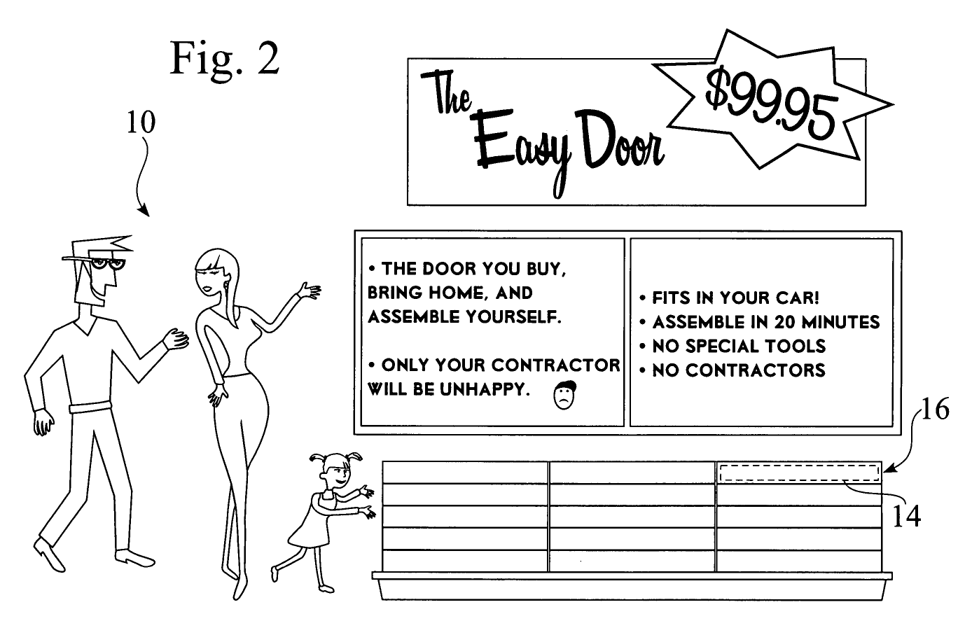

FIG. 1 depicts a family 10 arriving at a local retail store 12. Once inside the store 12, the shoppers 10 find a display for one embodiment of the present invention, the EasyDoor™ 14. As shown in FIG. 2, all the parts of an unassembled door 14 are packaged in a relatively small, portable and easy-to-transport package 16 that has its own carrying handle.

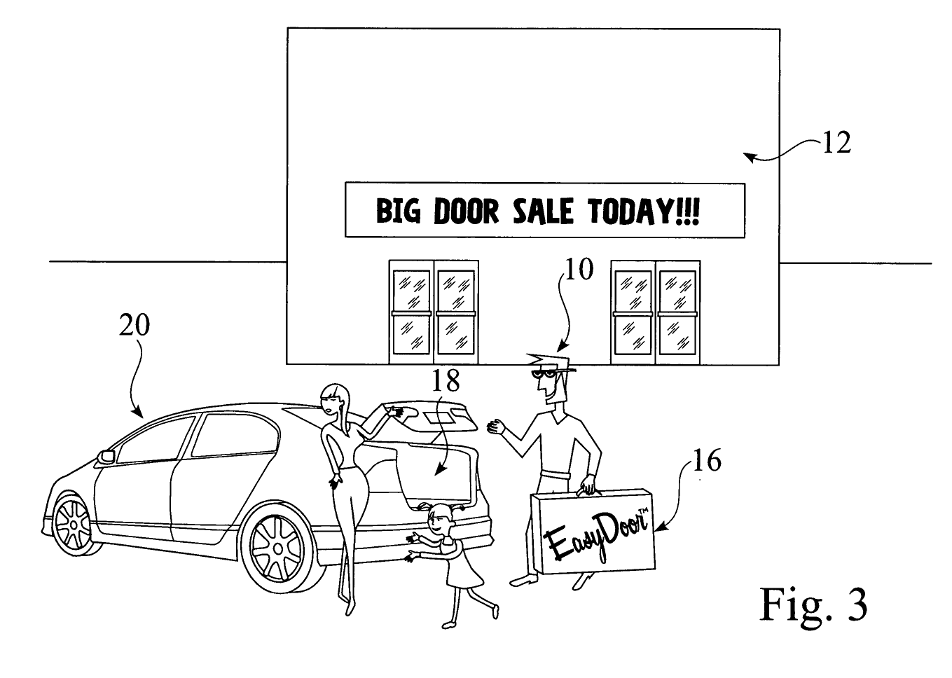

FIG. 3 shows the family 10 returning to the parking lot outside the retail store 12, where the EasyDoor™ package 16 is stowed in the trunk 18 of a typical family car 20. In this embodiment, the package 16 is so compact that it can even be carried inside the passenger compartment of the car 20.

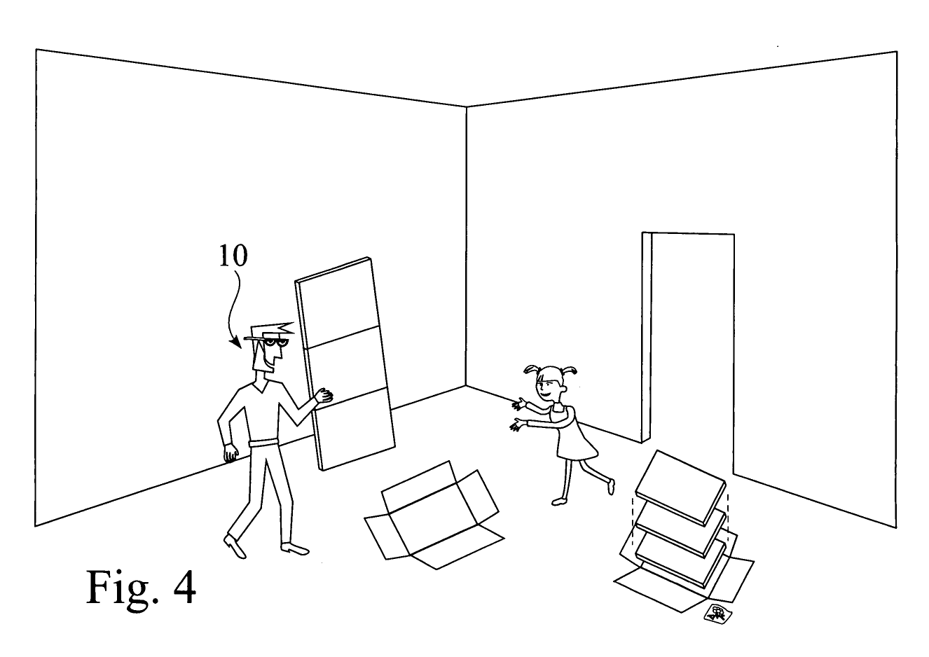

After arriving back home, the family 10 is ready to install the EasyDoor™ 14 as the interior entry door to Janie's room, as shown in FIG. 4. All of the components and connectors for the door are arranged in a stack in a package. The parts may be unassembled, or partially assembled. A typical size for the box containing this door is approximately two feet wide by three feet long by six inches high.

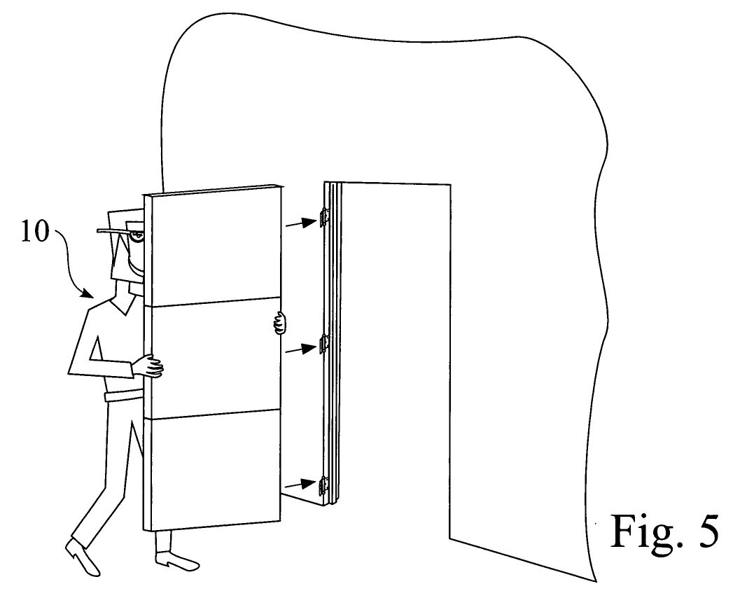

In this embodiment of the invention, the packaging 16 is opened and the components of the EasyDoor™ 14 are assembled by the consumer with ordinary skill without any special tools or expertise. Due to the compact size of the components, the door may be assembled in a small room without any special table or workbench. The components are fitted together either on the floor, or may be leaned against a wall as it is constructed, as shown in FIG. 5. The assembled door may be installed on hinges, hung on a track with rollers or guides, or attached to a door frame in any suitable fashion with various types of hardware. Other embodiments of the invention may include bi-fold doors or stationary panels.

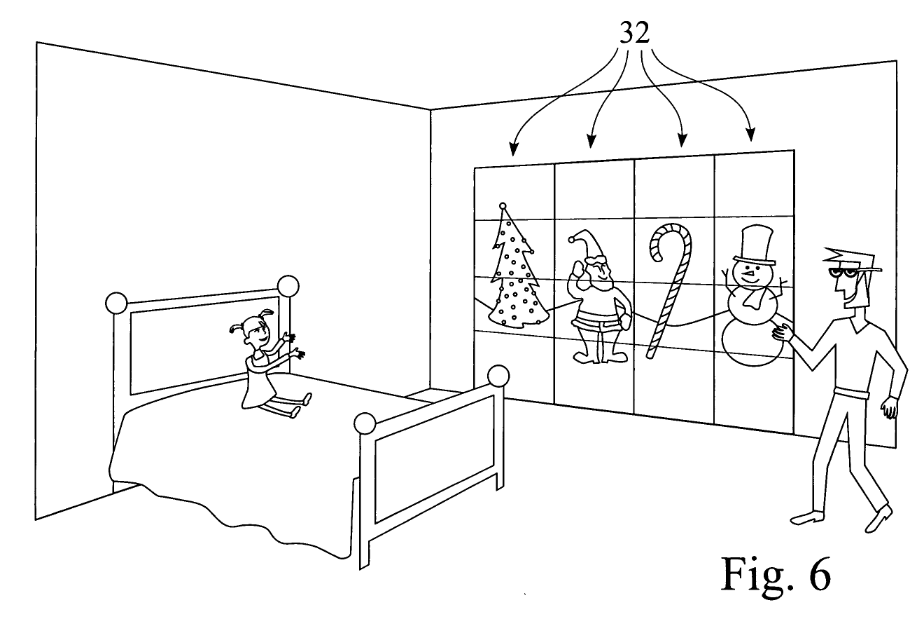

FIG. 6 offers a view of an alternative embodiment of the invention, which may include doors having:
panels with different color combinations, finishes or different materials;
sections with printed or painted scenes; or
surfaces bearing various illustrations of characters from books, cartoons or films.

This feature is especially beneficial for doors or panels installed in the rooms of children, who may wish to change the colors or scenes on door panels frequently to display favorite characters from popular books or movies.

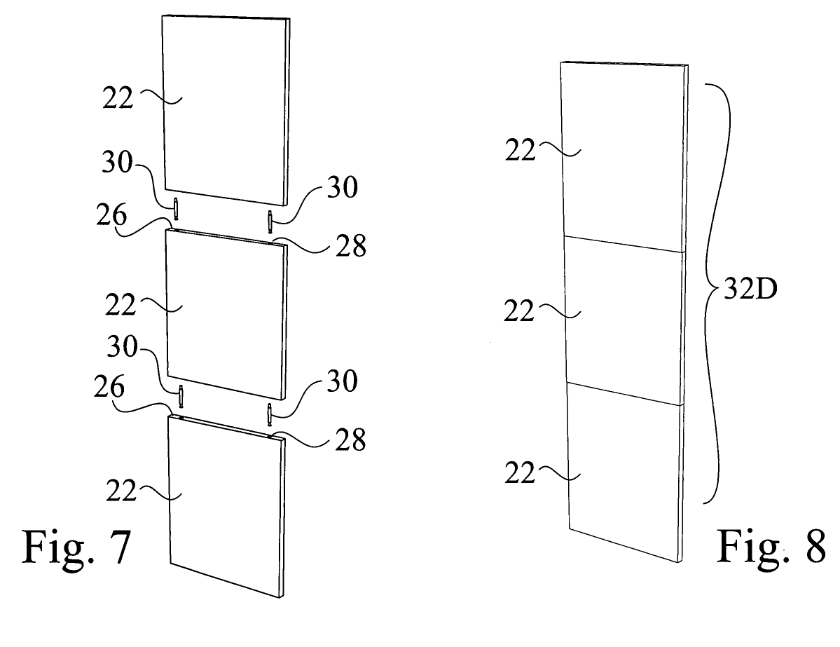

FIG. 7 furnishes an illustration of the components of one embodiment of the invention. In general, the present invention comprises one or more primary elements 22 and one or more secondary elements 24 (which may be optional, and which are described below). In general, each primary element 22 includes at least one transverse surface 26. In this Specification and in the Claims that follow, the term “transverse” is meant to connote any line, plane or surface that generally runs from side to side, including any horizontal or diagonal that is either parallel to the floor or to the ground, or forms an angle with the floor or ground that is less than ninety degrees. In one embodiment of the invention, when primary elements 22 are assembled, each transverse surface 26 is generally parallel to the floor or to the ground. In general, each primary element 22 has a transverse surface 26 which has a hole 28 that is configured to receive a connector 30. The term “hole” is intended to encompass a recess, mortise, slot, hollow, or any other suitable negative or evacuated space that is capable of receiving a connector 30. In an alternative embodiment, other alternative joining methods may be utilized, including glues, adhesives, epoxies and suitable types of compression fittings or other “snap-together” hardware.

In general, when primary elements 22 are combined with connectors 30, the result is a fully assembled structure 32. In some embodiments, the assembled structure 32 may also include secondary elements 24. These secondary elements may include rails 24r and stiles 24s, and are described below. In another embodiment of the invention, these transverse surfaces may be aligned diagonally, meaning that they form an angle with the floor or ground that is less than ninety degrees.

As an example, one of the particular embodiments of the invention is a door 32D. In this Specification and in the Claims that follow, the general reference character “32” pertains to a wide variety of assembled structures. More specific reference characters which include “32” and a capital letter, such as “32D,” pertain to a particular embodiment of the more generalized term “structure.”

In one embodiment of the invention which is portrayed in FIGS. 7 and 8, a door 32D generally comprises a combination of panels 22 and connectors 30. In this example, the panels 22 are the primary elements. Panels 22 are generally planar, rectangular sections that may be fabricated from natural wood, plywood, particle board, paper-wrapped chipboard, heavy paper, drywall, plastic, composite, glass, mirror, metal (such as aluminum) or any other suitable natural or man-made material. In this example, each panel 22 has the same width, measuring across from side to side along a line that is generally parallel to the floor. This type of panel 22 includes two transverse surfaces 26, which are the narrow top and bottom surfaces which are parallel to the floor when the door 32D is assembled. These transverse surfaces 26 are generally flat, and include holes 28 for connectors 30 that hold the finished door 32D together as a single unit. The connectors 30 may include dowels, rods, cylinders, pins, shafts, pegs, tenons, screws, bolts, brackets or any suitable projection, member, protuberance, appendage or mechanical coupling, engaging, grasping, bonding, joining, holding, locking, retaining or affixing means or a some device that snaps or presses together.

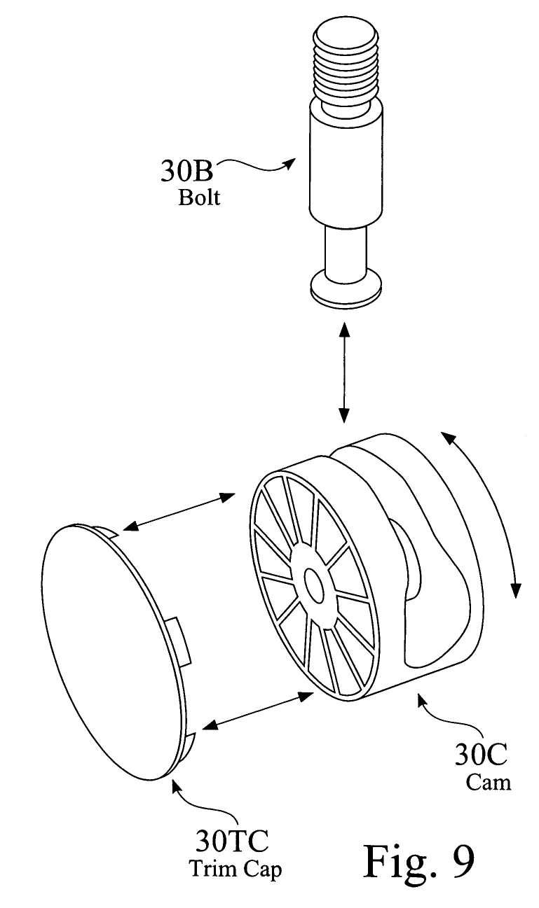

Specific examples of connectors 30 that may be utilized to implement the present invention are shown in FIG. 9. In one embodiment, cam and bolt connectors manufactured by Häfele of Archdale, N.C. may be used as connectors 30 to implement the present invention. This combination of a cam 30C and a bolt 30B (and an optional trim cap 30TC) are sometimes referred to as a “cam lock.” In general, a cam lock comprises two members that fit together, and then one of the members is twisted or rotated to supply a strong mechanical connection. The Häfele Maxiflix Universal Connector shown in FIG. 9 is composed of metal, but the connector employed by the present invention may be fashioned from wood, plastic or any other suitable material.

In another embodiment of the invention, some connectors 30 may be preinstalled, preset or pre-glued in the holes 28.

The particular embodiment of the door 32D shown in FIGS. 7 and 8 is assembled without special tools or carpentry skills. After opening the package 16, the consumer 10 removes a stack of three panels 22 and a set of connectors 30, which may be enclosed in a plastic bag. The three panels 22 may be placed on the floor in a row, so that the side edges of the three panels are aligned along the same line. The consumer 10 then inserts the connectors 30 in the holes 28 that have been pre-drilled in the transverse surfaces 26 of the panels 22. The top and bottom of the three panels 22 are then moved toward the center of the three panels 22, to engage the connectors 30.

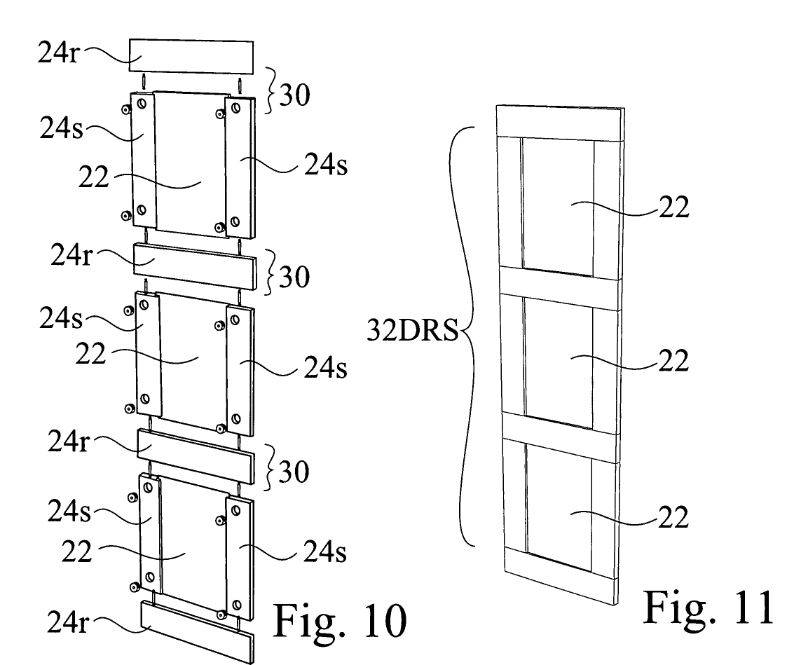

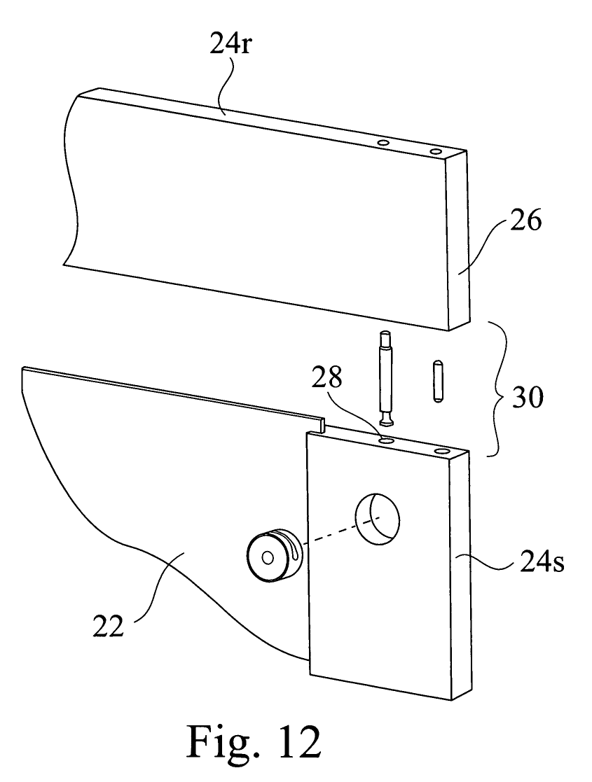

In an alternative embodiment, the door may also include secondary elements 24, such as rails 24r and stiles 24s. In general, a rail 24r is a horizontal element that abuts a panel 22. In general, a stile 24s is a vertical element that abuts a panel 22. In one embodiment, stiles 24s and 24r rails include a groove to insert a panel of a desired material. This embodiment is illustrated in FIGS. 10 and 11. The completed product with rails 24r and stiles 24s is shown as door 32DRS. The assembly procedure for this embodiment 32DRS is generally the same as the more basic embodiment 32D, except that additional elements 24r and 24s are assembled around the panels. A detailed view of the assembly of one embodiment of the invention is shown in FIG. 12.

An assembled door 32D or 32DRS may be installed using any suitable hardware, such as hinges, hangers, rails, tracks, guides or rollers. A new assembled door 32D or 32DRS may be mounted on existing or on new hardware.

This implementation of the invention may also be supplemented with other hardware, such as knobs, handles, entry lock sets. One of the panels in the unassembled kit may have a preformed hole to accept a knob or handle.

The apparatus and methods that are utilized to construct the door embodiments 32D and 32DRS of the present invention may be extended to all types of doors, including entry doors, closet doors, pocket doors, folding doors, saloon doors, sliding doors, interior doors and exterior doors.

In other embodiments, the apparatus and methods of the invention may be implemented in the general form of a desk, chair, table, bookcase, cabinet, storage box, bed, countertop, window or any other manifestation of furniture, furnishing or element of a building, shelter, enclosure or structure.

II. Additional Alternative Embodiments of the Invention.

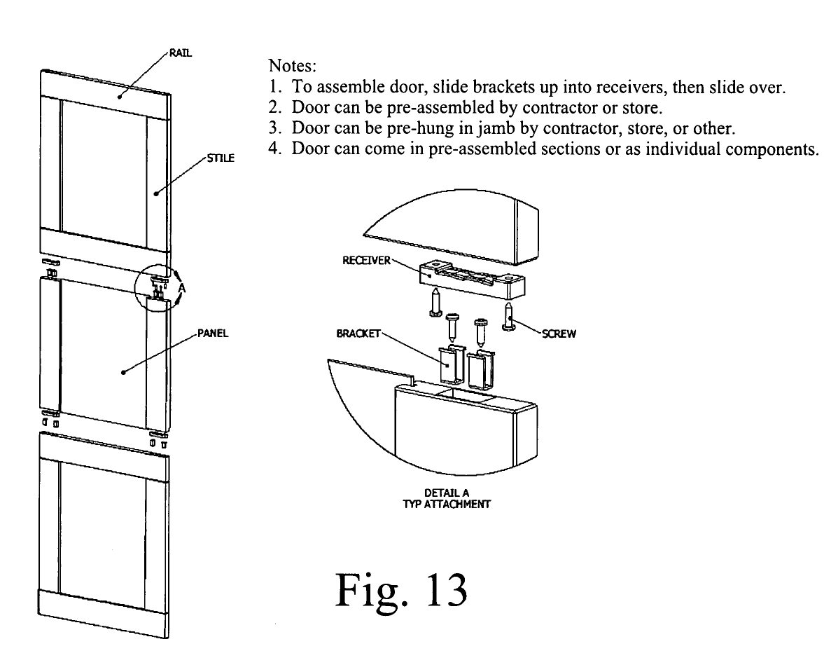

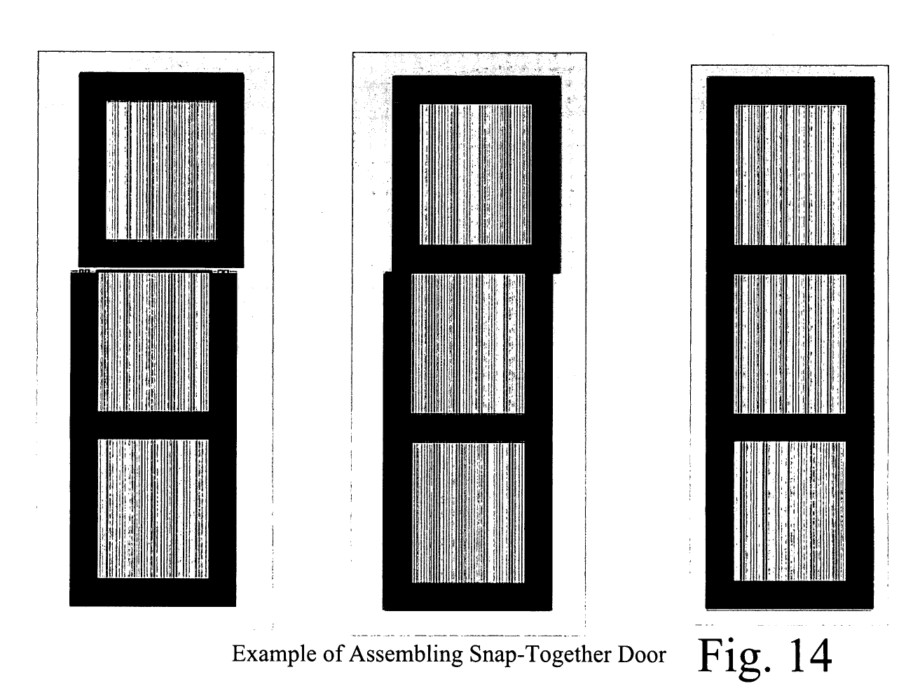

FIG. 13 depicts a snap-together door, comprising a plurality of sub-assemblies. Each sub-assemblies includes a central, planar panel. Each sub-assembly also includes a pair of stiles, and may include a pair of rails. Stiles are vertical elements that are attached to the sides of the central panel. Rails are horizontal elements that are attached to the top and bottom of the central panel. In one embodiment, the rails and stiles have channels which receive and generally enclose an edge of a central panel. Each of the elements of the sub-assembly may be manufactured from solid wood, wood laminates, plywood, paper-wrapped wood-derived products, paper-wrapped chipboard, plastic, metal, paper, drywall, composite, glass, mirror, metal (such as aluminum) or any other suitable natural or man-made material. The panels may be decorated with photos, images, patterns or other printed scenes.

In general, the invention utilizes a joining means to connect adjacent sub-assemblies. The joining means comprises any pair of connectors which may hold the adjacent sub-assemblies in place as part of a finished door. In general, the joining means comprises two elements. One of the elements is attached to one of the adjacent sub-assemblies, while a second element is attached to the other adjacent sub-assembly. In general, the two elements comprising the joining means are mounted so that they face each other when the adjacent sub-assemblies are brought together to assemble the entire door. The elements of the joining means are then engaged, fitted, locked or otherwise interact to hold the sub-assemblies in their proper position.

In one embodiment of the snap-together door, the sub-assemblies are held together by a joining means which is called “snap-together” hardware. This particular hardware includes a receiver and one or more brackets. Both the receiver and the brackets are mounted on a sub-assembly using screws or some other suitable connector. FIG. 13 shows a receiver mounted on the top sub-assembly, and a pair of brackets mounted on the middle sub-assembly. The brackets and the receiver face each other, are mounted on the stiles of different sub-assemblies, and are designed to “snap” or lock together to provide a mechanical connector between sub-assemblies. In this embodiment, the brackets are “U-shaped” projections which are mounted in a well, slot or channel in a stile. When the snap-together door is assembled, the projections are inserted up into the receiver, and are then moved laterally, where they “slide over” and then “snap” into spaces within the receiver, and are then held in place. FIG. 14 shows the assembly process for the snap-together door, including the lateral movement of one sub-assembly relative to another in the “slide-over” step that locks the sub-assemblies together.

The receiver and bracket hardware may be manufactured from metal, plastic or any other suitable material. The mechanical connection may also be fortified using glue or some other bonding agent.

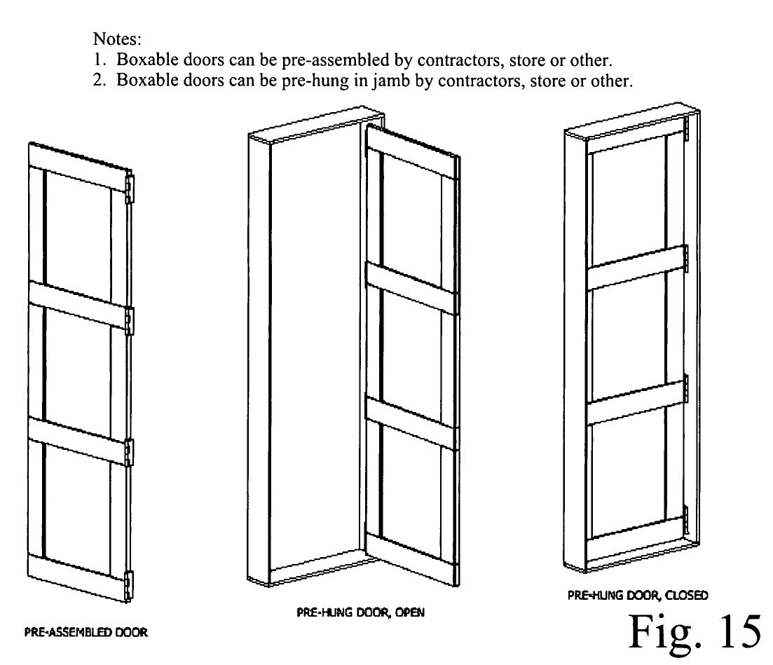

FIG. 15 provides multiple views of a pre-hung boxable door. As shown in FIG. 15, one of the embodiments of the present invention is shown attached to a jamb. In general, a jamb is a frame that substantially encloses or surrounds a door when it is closed. When opened, the door swings out from inside the jamb. In most instances, the door is attached to the jamb on a set of hinges.

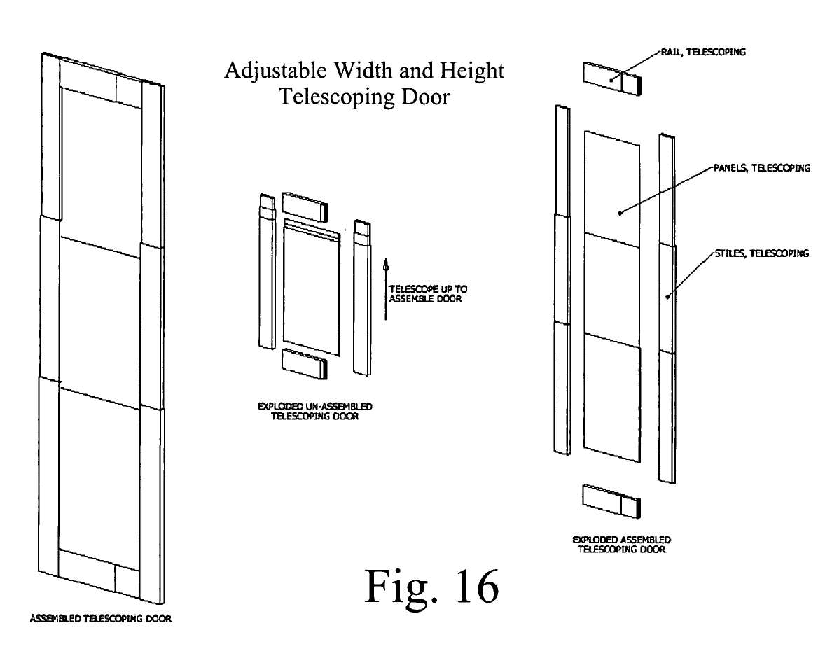

FIG. 16 provides views of yet another alternative embodiment, a telescoping door that offers an adjustable width and/or an adjustable height. Like the embodiment shown in FIG. 13, the embodiment shown in FIG. 16 comprises sub-assemblies that include central panels, stiles and rails. The embodiment shown in FIG. 16 is configured to allow the purchaser or user to customize the door by adjusting telescoping rails or stiles until the width or height of the door reaches the desired dimensions. This adjustment is accomplished using specialized “telescoping” rails and stiles which may be adjusted to provide a particular length. These variable rails and stiles comprise two or more members. In one implementation, a rail or stile may comprise an outer member and an inner member. The inner member is fitted inside the outer member, and is able to slide in and out of the outer member. When used in this Specification or in the Claims that follow, the term “telescoping” is intended to encompass any group of elements which are engaged, nested, held or fitted together, or which are otherwise mechanically coupled or physically interactive to provide a variable size, span, shape, configuration or dimension.

In another implementation, the telescoping rail or stile comprises three or more members. A first outer member encloses a second member that fits within the first. A third fits within the second, and so on.

As an additional feature, the telescoping rails and stiles may be locked into place using a set-screw or some other suitable securing or locking means. A door may be assembled using a combination of conventional and telescoping rails and/or stiles.

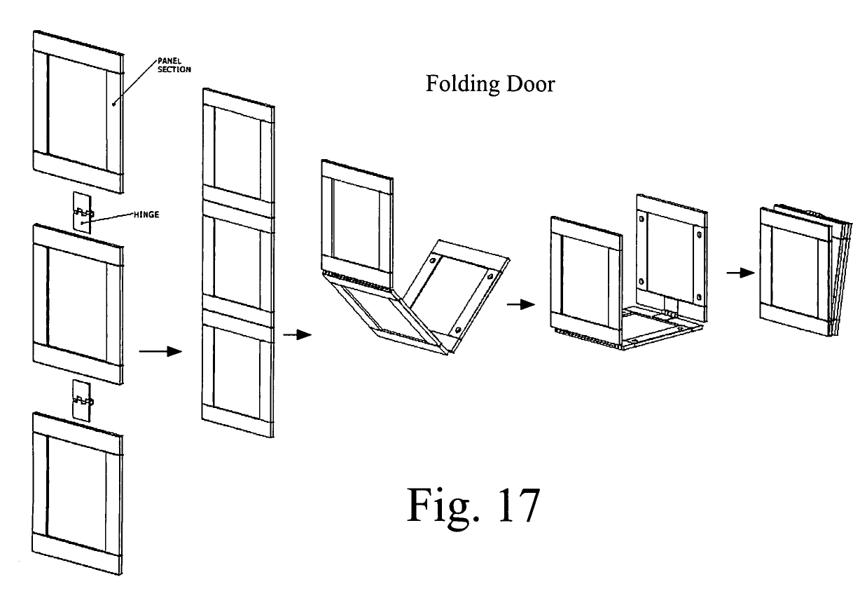

FIG. 17 offers multiple views of another alternative embodiment, a folding door. In this embodiment, a number of sub-assemblies are connected using hinges which are attached to a pair of horizontal rails. Each of the sub-assemblies comprise a central panel, rails and stiles. The foldable door may be assembled, folded and placed in a package that may be sold to a customer in a retail store. In general, the term “hinge” includes any device that may be affixed to two different elements to enable relative motion between the two different elements.

All of the embodiments shown in FIGS. 13 through 17 may be assembled by a retail consumer, by a contractor, by personnel in a retail store, or by personnel employed at the factory where the components are produced. Similarly, each of these embodiments may be pre-hung in a jamb by a retail consumer, by a contractor, by personnel in a retail store, or by personnel employed at the factory where the components are produced. Each of these embodiments may be purchased in pre-assembled sections, or as a kit that includes all the unassembled parts.

Although FIGS. 13-17 reveal embodiments made from three sub-assemblies, these embodiments may be implemented with any number of sub-assemblies that equals two or more.

The present invention may be implemented to create a door, panel, or other structural element of generally any shape, size or dimension. The present invention may be utilized to produce standard sized interior and exterior doors (for example, 24 or 36 by 80 inches); as well as small doors such as those used on kitchen or bathroom cabinets; or oversize doors, such as garage or shed doors.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing a Modular Assembly System that have been disclosed above are intended to educate the reader about preferred embodiments of the invention, and are not intended to constrain the limits of the invention or the scope of Claims.

### LIST OF REFERENCE CHARACTERS

10 Family
12 Retail store
14 EasyDoor™ (unassembled in box)
16 Easy to carry package
18 Trunk
20 Family car
22 Primary element (panel)
24 Secondary element
24r Rail
24s Stile
26 Transverse surface
28 Hole
30 Connector
30B Bolt
30C Cam
30TC Trim cap
32 Assembled structure
32D Assembled door
32DRS Assembled door with rails and stiles

What is claimed is:

1. An apparatus comprising:
a plurality of sub-assemblies;
each of said sub-assemblies including a panel and a rail; and
a joining means for providing a mechanical connection between two of said sub-assemblies;
each of said plurality of sub-assemblies being connected together to an adjacent sub-assembly with one of said joining means.

2. An apparatus as recited in claim 1, further comprising: a stile; said stile being attached to one of said panels.

3. An apparatus as recited in claim 1, in which each of said panels is attached to a pair of said rails and a pair of said stiles.

4. An apparatus as recited in claim 1, each of said sub-assemblies is attached to another adjacent sub-assembly; said pair of adjacent sub-assemblies being connected between a pair of said rails.

5. An apparatus as recited in claim 1, in which said plurality of sub-assemblies numbers two sub-assemblies.

6. An apparatus as recited in claim 1, in which said plurality of sub-assemblies numbers three sub-assemblies.

7. An apparatus as recited in claim 1, in which each of said joining means is attached to a pair of said rails.

8. An apparatus as recited in claim 1, in which said joining means comprises:
a first joining means element; and
a second joining means element;
said first and said second joining means elements for being aligned and then engaged to provide a mechanical connection.

9. An apparatus as recited in claim 1, in which said joining means includes:
a receiver; said receiver being mounted on one of said rails of a first of said plurality of sub-assemblies;
a bracket; said bracket being mounted in one of said rails of a second of said plurality of sub-assemblies;
said receiver and said bracket being generally aligned when said first and said second of said plurality of sub-assemblies are positioned for assembly;
said receiver and said bracket being engaged and then locked to hold said first and said second sub-assemblies in their proper place in a finished door.

10. An apparatus as recited in claim 9, in which two of said brackets are employed to engage one receiver.

11. An apparatus as recited in claim 1, in which said plurality of sub-assemblies are assembled by a manufacturer.

12. An apparatus as recited in claim 1, in which said plurality of sub-assemblies are assembled by a retailer.

13. An apparatus as recited in claim 1, in which said plurality of sub-assemblies are assembled by a contractor.

14. An apparatus as recited in claim 1 in which said plurality of sub-assemblies are assembled by a consumer.

15. An apparatus as recited in claim 1, further comprising a jamb; said plurality of sub-assemblies being hung in said jamb by a manufacturer.

16. An apparatus as recited in claim 1, further comprising a jamb; said plurality of sub-assemblies being hung in said jamb by a retailer.

17. An apparatus as recited in claim 1, further comprising a jamb; said plurality of sub-assemblies being hung in said jamb by a contractor.

18. An apparatus as recited in claim 1, further comprising a jamb; said plurality of sub-assemblies being hung in said jamb by a consumer.

19. An apparatus as recited in claim 1, in which said plurality of sub-assemblies and said joining means are sold to a consumer in a box sold by a retail store.

20. An apparatus as recited in claim 1, in which said panel is manufactured from solid wood.

21. An apparatus as recited in claim 1, in which said panel is manufactured from solid wood.

22. An apparatus as recited in claim 1, in which said panel is manufactured from solid wood.

23. An apparatus as recited in claim 1, in which said panel is manufactured from plywood.

24. An apparatus as recited in claim 1, in which said panel is manufactured from particle board.

25. An apparatus as recited in claim 1, in which said panel is manufactured from paper-wrapped chipboard.

26. An apparatus as recited in claim 1, in which said panel is manufactured from paper.

27. An apparatus as recited in claim 1, in which said panel is manufactured from cloth.

28. An apparatus as recited in claim 1, in which said panel is manufactured from plastic.

29. An apparatus as recited in claim 1, in which said panel is manufactured from metal.

30. An apparatus as recited in claim 1, in which said panel is manufactured from glass.

31. An apparatus as recited in claim 1, in which one of said panels is decorated with a photo.

32. An apparatus as recited in claim 1, in which one of said panels is decorated with a pattern.

33. An apparatus as recited in claim 1, in which one of said panels is decorated with an image.

34. An apparatus as recited in claim 1, in which said rail is a telescoping rail.

35. An apparatus as recited in claim 1, in which said stile is a telescoping stile.

36. An apparatus as recited in claim 1, further comprising a plurality of telescoping rails.

37. An apparatus as recited in claim 1, further comprising a plurality of telescoping stiles.

38. An apparatus as recited in claim 1, in which said joining means is a hinge; said hinge for connecting a pair of said sub-assemblies.

39. An apparatus as recited in claim 1, in which said joining means is a hinge; said hinge being affixed to a pair of said rails.
